(19) United States
(12) Patent Application Publication
(10) Pub. No.: US 2026/0284864 A1
(43) Pub. Date: Sep. 24, 2026

(54) Method for Automatically Picking Individual Items from Source Containers into Target Containers and Associated Conveyor System

(71) Applicant: Swisslog AG, Buchs/Aarau (CH)

(72) Inventor: Joerg Weber, Dortmund (DE)

(73) Assignee: Swisslog AG, Buchs/Aarau (CH)

(21) Appl. No.: 19/313,145

(22) Filed: Aug. 28, 2025

(30) Foreign Application Priority Data
Sep. 20, 2024 (EP) EP24201696.2

(51) Int. Cl. B25J 9/00; B25J 9/16; B65G 47/90

(52) U.S. Cl. CPC B25J 9/0093; B25J 9/1679; B65G 47/90

(57) ABSTRACT

A method for automatically picking general cargo objects from source containers into target containers using an automatically controlled robot arm in a picking region. An Associated conveyor system includes a first conveyor track and a second conveyor track, wherein the picking region of the conveyor system is formed by an arcuate first curved track portion of the first conveyor track and an arcuate second curved track portion of the second conveyor track. The conveyor system further includes a drivable cross conveyor configured to actively transfer each transport container between the first curved track portion of the first conveyor track and the second curved track portion of the second conveyor track.

### CROSS-REFERENCE TO RELATED APPLICATIONS

This application claims the benefit of priority under 35 U.S.C. § 119(a) to European Patent Application No. 24201696.2, filed Sep. 20, 2024, the disclosure of which is incorporated by reference herein in its entirety.

### TECHNICAL FIELD

The invention relates to a method for automatically picking general cargo objects from source containers into target containers, to an associated conveyor system for conveying transport containers on conveyor tracks, and to a computer program product.

### BACKGROUND

US 2014/0244026 A1 describes a system and a method for order processing. This comprises a robot arm with an end effector for gripping general cargo. An arcuate structure is movable within the robot arm's reach. A conveyor system brings the general cargo to the arcuate structure in containers and takes a container from which the general cargo have been taken back away from the curved structure. A control system executes an order by instructing the conveyor system to bring the general cargo to the arcuate structure, position the general cargo on the arcuate structure relative to the robot arm, determine a selected general cargo object for an order, instruct the robot arm to move the selected general cargo object from a removal location of the selected container to an output location at a target container, and to instruct the conveyor system to take the target container from the arcuate structure.

U.S. Pat No. 5,556,246 A describes a system for storing, retrieving and transporting goods, comprising rectangular units comprising air outlet means connected to a compressed air source to supply the units with compressed air in order to form an air cushion, and comprising a transverse movement device and a longitudinal movement device to be able to automatically selectively move a pallet that has been placed in position in the transverse or longitudinal direction on the air cushion.

EP 2 874 923 B1 describes an omnidirectional conveyor system module comprising at least two omnidirectional conveyor units arranged side by side, wherein the conveyor units each comprise at least one omnidirectional conveyor wheel and wherein the operational directions of the conveyor wheels of the conveyor units extend at an angle other than zero with respect to one another, wherein the conveyor units comprise an individually assigned drive motor for individually driving the at least one conveyor wheel.

### SUMMARY

The object of the invention is to provide a method for automatically picking general cargo objects from source containers into target containers, by means of which the picking process can be carried out particularly variably and efficiently using a robot arm.

The object is achieved by a method for automatically picking general cargo objects from source containers into target containers by means of an automatically controlled robot arm in a picking region, comprising the steps of:
conveying a source container or a target container to the picking region on a first conveyor track designed as a feed track, wherein the source container or the target container is moved in the picking region along an arcuate first curved track portion of the first conveyor track into an operating region of the robot arm,
automatically transferring the source container or target container conveyed on the feed track into the picking region from the arcuate first curved track portion of the first conveyor track into an arcuate second curved track portion of a second conveyor track lying next to the first curved track portion of the first conveyor track, which second conveyor track forms a removal track, and
conveying the source container or the target container out of the picking region on the second conveyor track, wherein the source container or the target container is moved in the picking region along the arcuate second curved track portion of the second conveyor track out of the operating region of the robot arm.

In an exemplary method according to the invention, each source container or target container is automatically conveyed to the picking region of a picking workstation by means of a first conveyor track. The first conveyor track has an end portion which is formed by the arcuate first curved track portion. Each source container or target container can therefore be moved as far as the distal end of the arcuate first curved track portion. Each source container or target container therefore cannot be transported beyond the distal end of the arcuate first curved track portion. In order to be able to remove each source container or target container from the picking region again, the source container or target container must be moved to the second conveyor track that extends beside the first conveyor track. The second conveyor track is used to convey source containers or target containers away from the picking region again.

For this purpose, the second conveyor track has an arcuate second curved track portion which extends beside the arcuate first curved track portion. The arcuate second curved track portion can extend in parallel with the arcuate first curved track portion in this respect. Therefore, a source container or target container is transferred, i.e. moved, from the arcuate first curved track portion to the arcuate second curved track portion in a radial direction relative to concentric circular paths which are predetermined by the arcuate first curved track portion and the arcuate second curved track portion.

The picking region is determined by the arcuate first curved track portion of the first conveyor track and the arcuate second curved track portion of the second conveyor track. The robot arm is preferably positioned in the center or near the center of the two circular paths on which the first curved track portion of the first conveyor track and the second curved track portion of the second conveyor track lie.

The robot arm can carry and guide an end effector, such as a gripper, which can automatically remove general cargo objects from each source container and automatically place or insert these general cargo objects into each target container. The operating region of the robot arm can be designed such that both the first curved track portion of the first conveyor track and the second curved track portion of the second conveyor track can be reached by the end effector of the robot arm in order to take general cargo objects from the source container and/or to deposit general cargo objects into the target container.

Alternatively, it may be sufficient for only one curved track portion of one conveyor track, which may in particular be the inner curved track portion, to be reachable by the end effector of the robot arm in order to take general cargo objects from the source container and/or to deposit general cargo objects into the target container, and for the other curved track portion of the other conveyor track, which may in particular be the outer curved track portion, not to be reachable by the end effector of the robot arm for taking general cargo objects from the source container and/or for depositing general cargo objects into the target container. Preferably, that curved track portion of the conveyor track which lies on the smaller curve radius, i.e. lies closest to the robot arm, can be reachable by the end effector of the robot arm.

For conveying a source container to and from the picking region, a first source container curved track portion of a first source container conveyor track can be provided and a second source container curved track portion of a second source container conveyor track can be provided. Accordingly, a first target container curved track portion of a first target container conveyor track can be provided and a second target container curved track portion of a second target container conveyor track can be provided in addition for conveying a target container to and from the picking region.

A source container can be automatically transferred in the radial direction between the first source container curved track portion and the second source container curved track portion, either in a radially outward direction or in the opposite radially inward direction. Accordingly, either the first source container curved track portion may be located on a larger radius and the second source container curved track portion may be located on a smaller radius, or the first source container curved track portion may be located on a smaller radius and the second source container curved track portion may be located on a larger radius. Preferably, it can be provided that the first source container curved track portion for conveying a source container is located on the smaller radius, i.e. the first source container curved track portion is accordingly positioned closer to the robot arm.

Analogously, a target container can be automatically transferred in the radial direction between the first target container curved track portion and the second target container curved track portion, either in a radially outward direction or in the opposite radially inward direction. Accordingly, either the first target container curved track portion may be located on a larger radius and the second target container curved track portion may be located on a smaller radius, or the first target container curved track portion may be located on a smaller radius and the second target container curved track portion may be located on a larger radius. Preferably, it can be provided that the first target container curved track portion for conveying a target container lies on the smaller radius, i.e. the first target container curved track portion is accordingly positioned closer to the robot arm.

By having the first curved track portion and the second curved track portion lying next to one another on different concentric tracks, one or more source containers and/or one or more target containers can be conveyed to and from the picking region on the same operating plane of the robot arm. This can avoid complex movement components in the vertical direction when controlling the robot arm. At the same time, the source containers and/or the target containers are conveyed to and from the installation location of the robot arm on concentric tracks so that the robot arm, which due to its design, for example as an articulated arm robot with six axes of rotation, comprises an at least approximately spherical operating space and can reach all the source containers and/or the target containers on the first curved track portions and second curved track portions in the same way over short distances. If necessary, the robot arm can already reach into a source container and/or target container if it is still moving in the first curved track portion or in the second curved track portion.

Furthermore, any individual source container and/or target container from a group of a plurality of source containers and/or target containers located on the first curved track portion of the first conveyor track can be transferred to the second curved track portion of the second conveyor track. Accordingly, the front source container and/or target container located at the distal end portion of the first curved track portion in the conveying direction does not always have to be transferred to the second curved track portion of the second conveyor track before the subsequent source containers and/or target containers. This allows for particularly flexible switching between source containers and/or target containers in the picking region. In particular, sequencing the source containers and/or the target containers to provide them to a robot arm in a spatial and/or temporal sequence can be important for increasing picking efficiency. The method can be applied particularly effectively especially when individual general cargo objects are to be introduced into a target container with a predetermined position and/or orientation.

General cargo objects can be automatically picked up by means of a gripper guided by the robot arm, in which the gripper automatically picks up the general cargo object in a specific gripping pose, for example by the robot arm automatically removing a general cargo object from a source container using its gripper. The general cargo objects can be present in the source container in an orderly or disorderly fashion. In such a case, for example, the position of the general cargo object to be gripped in the source container can be automatically recorded by means of at least one optical sensor, such as at least one camera, and on the basis of an image analysis, and the gripper of the robot arm can be controlled on the basis of the recorded position of the general cargo object such that the gripper can pick up the general cargo object in a specific gripping pose. Each gripping pose is defined by the relative position and orientation of the general cargo object with respect to the gripper when the gripper has grasped the general cargo object. The general cargo objects can then be automatically placed in a target container by the robot arm in an orderly or disorderly fashion.

The source container or target container conveyed on the feed track into the picking region can be transferred from the arcuate first curved track portion of the first conveyor track to the arcuate second curved track portion of the second conveyor track located beside the first curved track portion of the first conveyor track by means of an automatically controlled drivable cross conveyor or transfer conveyor.

The method can provide that the cross conveyor moves a source container or target container in a radial direction from the arcuate first curved track portion of the first conveyor track to the arcuate second curved track portion of the second conveyor track located beside the first curved track portion of the first conveyor track. A source container or a target container can be moved, i.e. transferred, either in a radially outward direction or in the opposite radially inward direction, depending on whether the arcuate first curved track portion of the first conveyor track is configured on the radial inside or radial outside of the arcuate second curved track portion of the second conveyor track.

The source container or target container conveyed on the feed track into the picking region can be transferred from the arcuate first curved track portion of the first conveyor track to the arcuate second curved track portion of the second conveyor track located beside the first curved track portion of the first conveyor track by means of the automatically controlled robot or by means of an auxiliary robot arm that differs from the automatically controlled robot.

In such a design variant, one or more cross conveyors can accordingly be replaced by the robot arm or an additional auxiliary robot arm. The robot arm or the auxiliary robot arm can be configured as a cross conveyor in this respect and programmed in such a way that it can perform the task of a cross conveyor. This has the advantage, among other things, that in the case of several locations where a transfer movement is to be executable, a plurality of special cross conveyor devices do not have to be arranged, but it is sufficient if a single robot arm or auxiliary robot arm replaces the plurality of cross conveyor apparatuses. This can be achieved particularly cost-effectively if no additional auxiliary robot arms and no special cross conveyor apparatuses are required, but instead the robot arm responsible for the picking process also transfers the source containers and/or the target containers.

However, if the robot arm responsible for the picking process is already being fully utilized by the picking process, it certainly makes sense to provide separate cross conveyor apparatuses or an additional auxiliary robot arm. A simple type of cross conveyor apparatus can be, for example, a pusher. This enables a source container or a target container to be pushed sideways by means of a simple, in particular linear, pushing movement.

Instead of being carried out by means of dedicated conveyor tracks and/or dedicated cross conveyor apparatuses, the steps of the method, in particular also the various variants of the method, can alternatively also be carried out by means of an omnidirectional conveyor table which extends over the operating region of the robot arm in the picking region.

The omnidirectional conveyor table can, for example, have a similar design to an omnidirectional conveyor table according to US 5 556 246 A or according to EP 2 874 923 B1.

The omnidirectional conveyor table may comprise a plurality of omnidirectional conveyor elements, wherein the omnidirectional conveyor elements may be arranged in patterns, in particular in uniform patterns, such as in rows and columns or in grid structures or honeycomb structures. The plurality of omnidirectional conveyor elements are located in a common plane and define the surface of the omnidirectional conveyor table on which containers, in particular the source containers and target containers, can be automatically moved on freely programmable tracks. For this purpose, the omnidirectional conveyor elements can be automatically controlled individually or in groups in order to specify a freely specified direction of movement. A plurality of adjacent omnidirectional conveyor elements can interact in such a way that a total movement vector is formed, according to which a container then moves on the omnidirectional conveyor table. This means that any container can either perform a straight-line movement on the omnidirectional conveyor table, an arc-shaped movement on the omnidirectional conveyor table or can even be rotated or turned on the spot.

The omnidirectional conveyor elements each comprise a plurality of drive elements in order to be able to transmit a driving force to a container placed thereon, and a plurality of automatically controllable motors which can control the drive elements individually. The motors of the plurality of omnidirectional conveyor elements can be automatically controlled by a conveyor table control apparatus. The conveyor table control apparatus can be configured and programmed to specify the movements according to the method for the source containers and/or the target containers in the form of first curved tracks that simulate a first conveyor track, second curved tracks that simulate a second conveyor track, and in the form of transfer movement tracks that can thus simulate a cross conveyor.

This has the advantage that the first curved tracks, the second curved tracks and the transfer movement tracks can be programmed more freely and thus more flexibly than is possible with directional conveyor tracks or mechanical conveyor tracks and mechanical cross conveyors. For example, the curve radii on which the containers move along a curved track can be dynamically changed so that the containers moved by the omnidirectional conveyor table can move on variable curved tracks. If necessary, the transfer movement track can then also include an additional movement component running in the circumferential direction instead of having a purely radial movement direction. Accordingly, a container may then move on a spiral movement track to carry out the transfer movement, if necessary. Preference can certainly be given to a movement track for the containers on the first curved track portion and on the second curved track portion which has a constant radius of curvature. This allows the containers to be moved around the robot arm at constant distance from the robot arm.

In a special development, the method can thus be characterized by the steps of:
conveying the source container or the target container to the picking region on the first conveyor track, the source container or the target container thereby being moved along the arcuate first curved track portion of the first conveyor track into the operating region of the robot arm in the picking region, by at least the first curved track portion being formed by the omnidirectional conveyor table, which comprises a plurality of omnidirectional conveyor units that can be driven individually or in groups and are controlled such that a conveyed source container or target container on the omnidirectional conveyor table is automatically moved along a first trajectory which forms the arcuate first curved track portion,
automatically transferring the source container or target container conveyed on the feed track into the picking region from a position on the first trajectory to a position on a second trajectory that extends alongside the first trajectory by controlling the omnidirectional conveyor units in such a way that a source container or target container on the omnidirectional conveyor table that is to be transferred is automatically moved radially from the first trajectory to the second trajectory, which forms the arcuate second curved track portion, and
conveying the source container or the target container out of the picking region on a second conveyor track which extends along the second trajectory, the source container or the target container thereby being moved in the picking region along the arcuate second curved track portion of the second conveyor track out of the operating region of the robot arm by at least the second curved track portion being formed by the omnidirectional conveyor table, the omnidirectional conveyor units of which are controlled in such a way that a source container or target container on the omnidirectional conveyor table that is to be conveyed away is automatically moved along the second trajectory.

In an alternative or additional development, the method can be characterized by the steps of:
conveying a source container to the picking region within the operating region of the robot arm on a first source container curved track portion of a first source container conveyor track extending in an arc shape around the robot arm, in which the first source container curved track portion forms a source container feed track,
conveying a target container to the picking region within the operating region of the robot arm on a first target container curved track portion of a first target container conveyor track extending in an arc shape around the robot arm, in which the first target container curved track portion forms a target container feed track,
automatically moving at least one general cargo object from the source container to the target container by means of the robot arm before or after automatically transferring the source container and/or the target container,
automatically transferring the source container conveyed on the source container feed track into the picking region from the arcuate first source container curved track portion of the first source container conveyor track to an arcuate second source container curved track portion of a second source container conveyor track, which is located beside the first source container curved track portion of the first source container conveyor track and forms a source container removal track,
automatically transferring the target container conveyed on the target container feed track into the picking region from the arcuate first target container curved track portion of the first target container conveyor track to an arcuate second target container curved track portion of a second target container conveyor track, which is located beside the first target container curved track portion of the first target container conveyor track and forms a target container removal track,
conveying the source container out of the picking region on the second source container conveyor track, wherein the source container is moved in the picking region along the arcuate second source container curved track portion of the second source container conveyor track out of the operating region of the robot arm,
conveying the target container out of the picking region on the second target container conveyor track, wherein the target container is moved in the picking region along the arcuate second target container curved track portion of the second target container conveyor track out of the operating region of the robot arm.

In the method just described, the automatic transfer of the source container can be carried out at a distal end portion of the first source container curved track portion and the second source container curved track portion, which distal end portion is remote from an opposite connection portion of the first source container curved track portion and the second source container curved track portion, at which connection portion connecting conveyor tracks are connected to the first source container conveyor track and the second source container conveyor track, and/or the automatic transfer of the target container is carried out at a distal end portion of the first target container curved track portion and the second target container curved track portion, which distal end portion is remote from an opposite connection portion of the first target container curved track portion and the second target container curved track portion, at which connection portion connecting conveyor tracks are connected to the first target container conveyor track and second target container conveyor track.

Alternatively, the automatic transfer of the source container is carried out at a proximal connection portion of the first source container curved track portion and the second source container curved track portion, which proximal connection portion is remote from an opposite end portion of the first source container curved track portion and the second source container curved track portion, wherein connecting conveyor tracks are connected to the first source container conveyor track and the second source container conveyor track at the proximal connection portion, and/or the automatic transfer of the target container is carried out at a proximal connection portion of the first target container curved track portion and the second target container curved track portion, which proximal connection portion is remote from an opposite end portion of the first target container curved track portion and the second target container curved track portion, wherein connecting conveyor tracks are connected to the first target container conveyor track and the second target container conveyor track at the proximal connection portion.

The first source container curved track portion and the second source container curved track portion may extend over the same source container angular range, the first target container curved track portion and the second target container curved track portion may extend over the same target container angular range, and the source container angular range may differ from the target container angular range such that a different number of source containers and target containers can be positioned within the operating region of the robot arm.

The object of the invention is also achieved by a conveyor system for conveying transport containers on conveyor tracks, in particular for carrying out a method according to any one of the embodiments described, comprising:
at least one first conveyor track, which is designed and configured as a feed track, for conveying transport containers to a picking region of the conveyor system,
at least one second conveyor track, which is designed and configured as a removal track, for conveying transport containers out of the picking region of the conveyor system,
wherein the picking region of the conveyor system is formed by an arcuate first curved track portion of the first conveyor track and an arcuate second curved track portion of the second conveyor track lying next to the first curved track portion of the first conveyor track, and comprising
a drivable cross conveyor which is designed and configured to actively transfer each transport container between the first curved track portion of the first conveyor track and the second curved track portion of the second conveyor track.

The first conveyor track and/or the second conveyor track can each be designed as a roller track. For this purpose, each roller track can comprise a plurality of successive rollers, which are aligned with their axes of rotation at least substantially parallel to one another and are arranged at equal distances from one another. Depending on requirements, the rollers may or may not be driven.

As an alternative to roller tracks, the first conveyor track and/or the second conveyor track can each also be designed as a belt conveyor.

The cross conveyor can, for example, be designed as at least one belt or chain lifting transfer unit. In a special design, the cross conveyor can also be referred to as a roller track converter. In a corresponding track portion of a roller track, a transfer blade can be arranged between each two immediately adjacent rollers and can be mounted in an automatically adjustable manner between a storage position, in which the movement blade is hidden below a support plane of the rollers, and an operating position in which the movement blade projects upward beyond the support plane of the rollers so that a container arranged in this plane is lifted off the support rollers and comes to rest on the movement blade. Each cross conveyor can comprise two or more movement blades, which can collectively hold a transport container in order to move it from the first conveyor track to the second conveyor track.

The at least one first conveyor track can accordingly be formed by a first roller track comprising a plurality of rotationally drivable first rollers that are evenly spaced apart from one another in the conveying direction, the at least one second conveyor track can be formed by a second roller track comprising a plurality of rotationally drivable second rollers that are evenly spaced apart from one another in the conveying direction, and/or the drivable cross conveyor can be formed by at least one belt or chain lifting transfer unit arranged between two adjacent rollers of the first conveyor track and/or the second conveyor track each time.

The first curved track portion of the first roller track and the second curved track portion of the second roller track can be arranged in parallel next to one another such that the first curved track portion and the second curved track portion lie on two different concentric circular paths having different radii.

The robot arm can preferably be positioned in the center of the two circular paths on which the first curved track portion of the first roller track and the second curved track portion of the second roller track lie.

In this way, all the source containers and/or target containers on the first curved track portion and the second curved track portion can be reached in the same way by the robot arm. In the case of a six-axis articulated arm robot, for example, the end effector of the robot arm can be easily moved along the entire stretch of the first curved track portion and/or the second curved track portion by automatically rotating the proximal first axis of rotation (carousel of the robot arm). The other axes of rotation (two to six) can maintain unchanged rotational positions.

The at least one first conveyor track and/or the first curved track portion can be formed by an omnidirectional conveyor table comprising a plurality of omnidirectional conveyor units that can be driven individually or in groups and which can be controlled in such a way that a conveyed source container or target container on the omnidirectional conveyor table can be automatically moved along a first trajectory which forms the first conveyor track and/or the arcuate first curved track portion, and the at least one second conveyor track and/or the second curved track portion is formed by the omnidirectional conveyor table, the omnidirectional conveyor units of which can be controlled in such a way that a source container or target container on the omnidirectional conveyor table that is to be conveyed away can be automatically moved along a second trajectory which forms the second conveyor track and/or the arcuate second curved track portion, and/or the drivable cross conveyor is formed by the omnidirectional conveyor table, the omnidirectional conveyor units of which can be controlled in such a way that a source container or target container on the omnidirectional conveyor table that is to be automatically transferred can be automatically moved radially to the first trajectory and second trajectory from a position on the first trajectory to a position on the second trajectory.

The omnidirectional conveyor table may comprise a plurality of omnidirectional conveyor elements, wherein the omnidirectional conveyor elements may be arranged in patterns, in particular in uniform patterns, such as in rows and columns or in grid structures or honeycomb structures. The plurality of omnidirectional conveyor elements are located in a common plane and define the surface of the omnidirectional conveyor table on which containers, in particular the source containers and target containers, can be automatically moved on freely programmable tracks. For this purpose, the omnidirectional conveyor elements can be automatically controlled individually or in groups in order to specify a freely specified direction of movement. A plurality of adjacent omnidirectional conveyor elements can interact in such a way that a total movement vector is formed, according to which a container then moves on the omnidirectional conveyor table. This means that any container can either perform a straight-line movement on the omnidirectional conveyor table, an arc-shaped movement on the omnidirectional conveyor table or can even be rotated or turned on the spot.

The omnidirectional conveyor elements each comprise a plurality of drive elements in order to be able to transmit a driving force to a container placed thereon, and a plurality of automatically controllable motors which can control the drive elements individually. The motors of the plurality of omnidirectional conveyor elements can be automatically controlled by a conveyor table control apparatus. The conveyor table control apparatus can be configured and programmed to specify the movements according to the method for the source containers and/or the target containers in the form of first curved tracks that simulate a first conveyor track, second curved tracks that simulate a second conveyor track, and in the form of transfer movement tracks that can thus simulate a cross conveyor.

This has the advantage that the first curved tracks, the second curved tracks and the transfer movement tracks can be programmed more freely and thus more flexibly than is possible with mechanical conveyor tracks and mechanical cross conveyors. For example, the curve radii on which the containers move along a curved track can be dynamically changed so that the containers moved by the omnidirectional conveyor table can move on variable curved tracks. If necessary, the transfer movement track can then also include an additional movement component running in the circumferential direction instead of having a purely radial movement direction. Accordingly, a container may then move on a spiral movement track to carry out the transfer movement, if necessary. Preference can certainly be given to a movement track for the containers on the first curved track portion and on the second curved track portion which has a constant radius of curvature. This allows the containers to be moved around the robot arm at constant distance from the robot arm.

The object is also achieved by a computer program product comprising a machine-readable carrier on which a program code is stored, which can be read by a picking control device of a conveyor system, in particular a conveyor system according to any one of the embodiments described, and which instructs and/or configures the picking control device to carry out a method according to any one of the embodiments described when the program code is executed by the picking control device.

The computer program product can be a CD, a DVD, or a USB stick, for example. However, the computer program product can also be a control card on which microprocessors are integrated. However, the computer program product can also be implemented in the form of a download that can be offered and sold over the Internet or another network.

The machine-readable carrier can thus be a CD, a DVD, or a microprocessor on which the program code is stored. However, the machine-readable carrier can also be a hard disk or an SSD drive onto which the program code has been downloaded, e.g., by means of a download-in particular, in the form of data packets.

The program code may be represented by an edited program and/or data stored on the machine-readable carrier.

By reading out the edited program and/or the data, the reading picking control device reading it out is designed and/or configured to be able to carry out the method according to the invention by controlling the conveyor system according to the invention to move the source containers and/or target containers accordingly.

Specific embodiments of the invention are explained in more detail in the following description with reference to the accompanying drawings. Specific features of these exemplary embodiments, possibly considered individually or in further combinations, can represent general features of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a flow chart of the steps in the basic method according to one aspect of the invention,

FIG. 2 is a schematic representation of a first example embodiment of a conveyor system, in particular for carrying out the method according to the invention,

FIG. 3 is a schematic representation of a second example embodiment of a conveyor system, in particular for carrying out the method according to the invention,

FIG. 4 is a schematic representation of a third example embodiment of a conveyor system, in particular for carrying out the method according to the invention,

FIG. 5 is a schematic representation of a fourth example embodiment of a conveyor system, in particular for carrying out the method according to the invention, and

FIG. 6 is a schematic representation of a specific embodiment of a conveyor system designed as an omnidirectional conveyor table, in particular for carrying out the method according to the invention.

### DETAILED DESCRIPTION

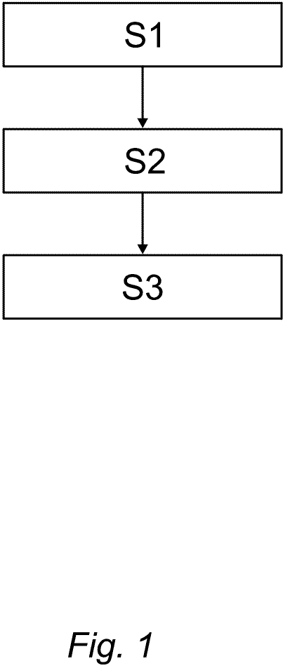

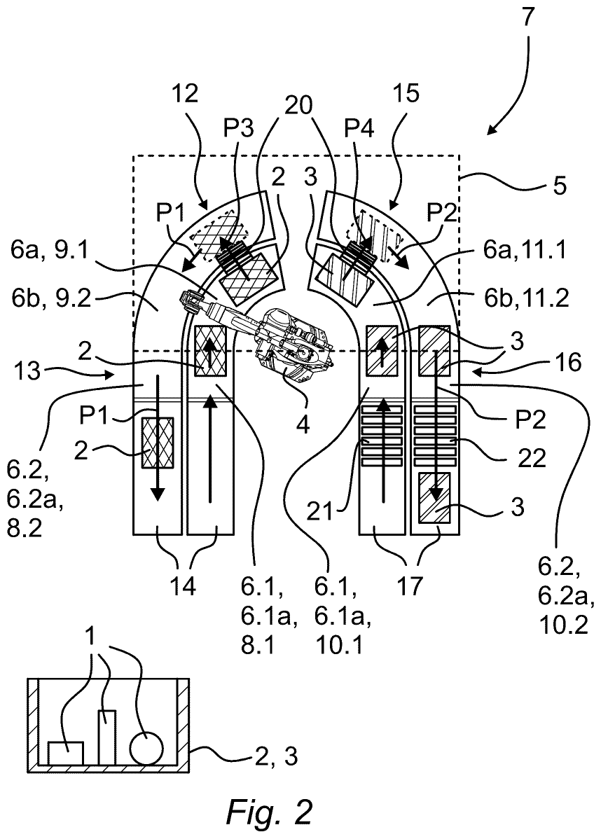

FIG. 1 shows a flow chart of the steps of an exemplary basic method according to aspects of the invention for automatically picking general cargo objects 1 from source containers 2 into target containers 3 by means of an automatically controlled robot arm 4 in a picking region 5. The reference numerals not shown in FIG. 1 can be found in FIG. 2 to FIG. 6.

In a first step S1 of the method, a source container 2 or a target container 3 is conveyed to the picking region 5 on a first conveyor track 6.1, which is configured as a feed track, wherein the source container 2 or the target container 3 is moved along an arcuate first curved track portion 6a of the first conveyor track 6.1 into an operating region of the robot arm 4 in the picking region 5.

In a second step S2 of the method, the source container 2 or target container 3 conveyed on the feed track into the picking region 5 is automatically transferred from the arcuate first curved track portion 6a of the first conveyor track 6.1 to an arcuate second curved track portion 6b of a second conveyor track 6.2 lying next to the first curved track portion 6a of the first conveyor track 6.1 and forms a removal track.

In a third step S3 of the method, the source container 2 or the target container 3 is conveyed out of the picking region 5 on the second conveyor track 6.2, wherein the source container 2 or the target container 3 is moved in the picking region 5 along the arcuate second curved track portion 6b of the second conveyor track 6.2 out of the operating region of the robot arm 4.

FIG. 2 to FIG. 6 illustrate, using concrete configurations of a conveyor system each time, how the method can be carried out each time.

A source container 2 can be conveyed to the picking region 5 in the operating region of the robot arm 4 on a first source container curved track portion 9.1 of a first source container conveyor track 8.1 which extends in an arc shape around the robot arm 4, in which the first source container curved track portion 9.1 forms a source container feed track.

A target container 3 can be conveyed to the picking region 5 in the operating region of the robot arm 4 on a first target container curved track portion 11.1 of a first target container conveyor track 10.1 that extends in an arc shape around the robot arm 4, in which the first target container curved track portion 11.1 forms a target container feed track.

At least one general cargo object 1 can be automatically moved from the source container 2 to the target container 3 by means of the robot arm 4, for example the source container 2 and the target container 3 are automatically transferred.

The source container 2 conveyed on the source container feed track into the picking region 5 can be automatically transferred from the arcuate first source container curved track portion 9.1 of the first source container conveyor track 8.1 to an arcuate second source container curved track portion 9.2 of a second source container conveyor track 8.2 located beside to the first source container curved track portion 9.1 of the first source container conveyor track 8.1, which second source container conveyor track forms a source container removal track.

Accordingly, the target container 3 conveyed on the target container feed track into the picking region 5 can also be automatically transferred from the arcuate first target container curved track portion 11.1 of the first target container conveyor track 10.1 to an arcuate second target container curved track portion 11.2 of a second target container conveyor track 10.2 located beside to the first target container curved track portion 11.1 of the first target container conveyor track 10.1, which second target container conveyor track forms a target container removal track.

The source container 2 is conveyed out of the picking region 5 on the second source container conveyor track 8.2 by moving the source container 2 in the picking region 5 along the arcuate second source container curved track portion 9.2 of the second source container conveyor track 8.2 out of the operating region of the robot arm 4, as indicated by the arrows P1.

Accordingly, the target container 3 is conveyed out of the picking region 5 on the second target container conveyor track 10.2 by moving the target container 3 in the picking region 5 along the arcuate second target container curved track portion 11.2 of the second target container conveyor track 10.2 out of the operating region of the robot arm 4, as indicated by the arrows P2.

In the case of the first embodiment according to FIG. 2, the automatic transfer of the source container 2 takes place at a distal end portion 12 of the first source container curved track portion 9.1 and the second source container curved track portion 9.2, as indicated by the arrow P3, which distal end portion 12 is remote from an opposite connection portion 13 of the first source container curved track portion 9.1 and the second source container curved track portion 9.2, at which connection portion connecting conveyor tracks 14 are connected to the first source container conveyor track 8.1 and the second source container conveyor track 8.2.

Similarly, in the case of the first embodiment according to FIG. 2, the automatic transfer of the target container 3 takes place at a distal end portion 15 of the first target container curved track portion 11.1 and the second target container curved track portion 11.2, as indicated by the arrow P4, which distal end portion 15 is remote from an opposite connection portion 16 of the first target container curved track portion 11.1 and the second target container curved track portion 11.2, at which connection portion connecting conveyor tracks 17 are connected to the first target container conveyor track 10.1 and the second target container conveyor track 10.2.

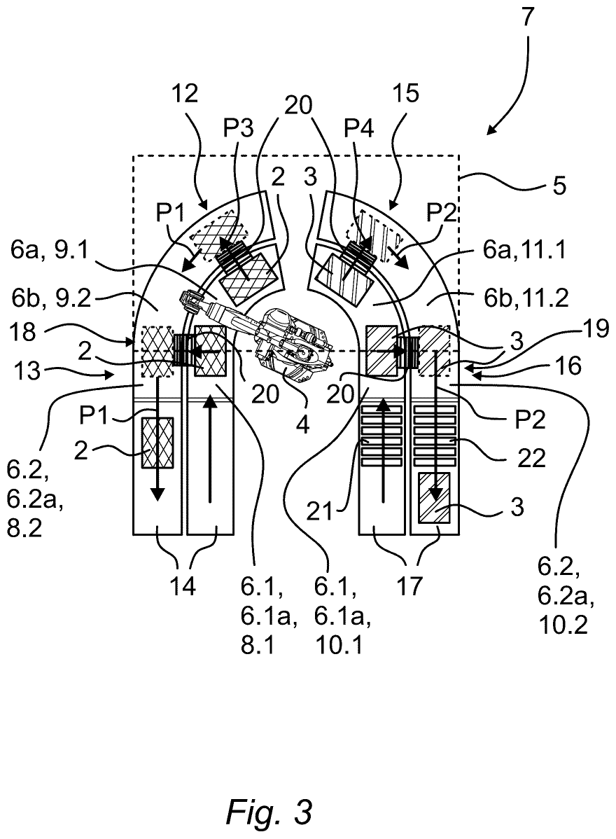

In a modification, in the second embodiment according to FIG. 3, the automatic transfer of the source container 2 can additionally be carried out at a proximal connection portion 18 of the first source container curved track portion 9.1 and the second source container curved track portion 9.2, which proximal connection portion 18 is remote from the opposite end portion 12 of the first source container curved track portion 9.1 and the second source container curved track portion 9.2, wherein the connecting conveyor tracks 14 are connected to the first source container conveyor track 8.1 and the second source container conveyor track 8.2 at the proximal connection portion 18.

In the same way, in the case of the second embodiment according to FIG. 3, the automatic transfer of the target container 3 takes place at a proximal connection portion 19 of the first target container curved track portion 11.1 and the second target container curved track portion 11.2, which proximal connection portion 19 is remote from the opposite end portion 15 of the first target container curved track portion 11.1 and the second target container curved track portion 11.2, wherein the connecting conveyor tracks 17 are connected to the first target container conveyor track 10.1 and the second target container conveyor track 10.2 at the proximal connection portion 19.

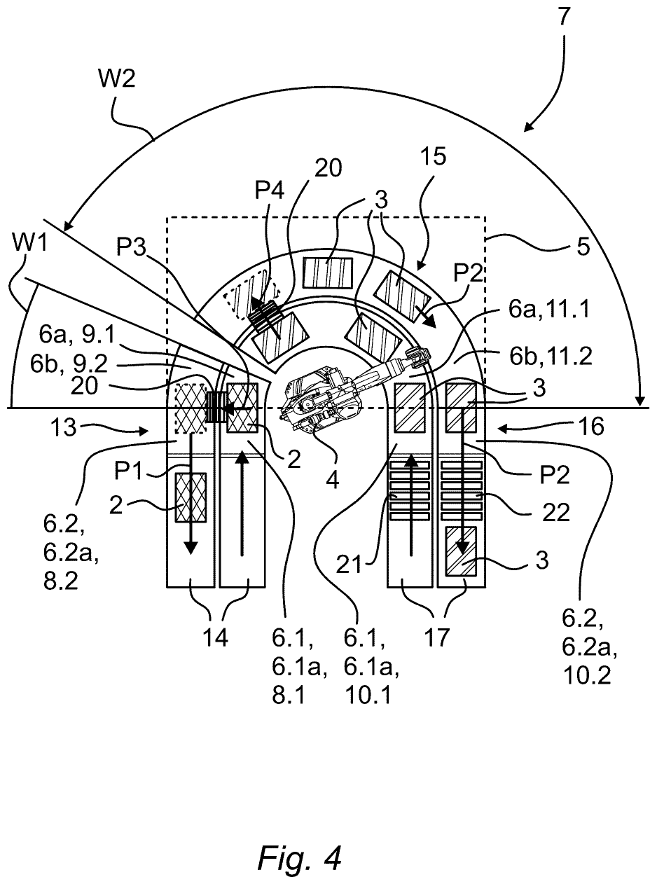

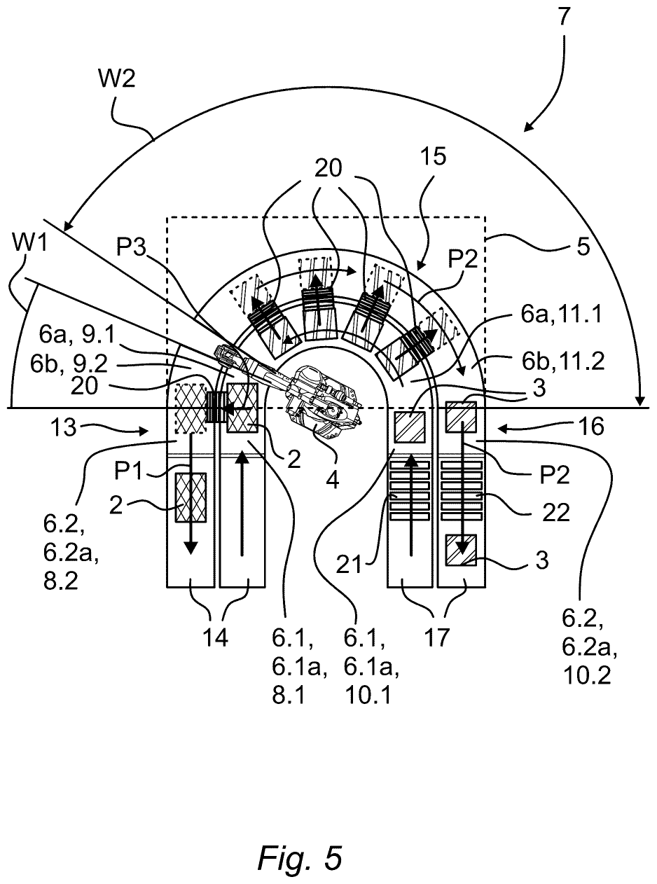

In the case of the third embodiment according to FIG. 4 and the fourth embodiment according to FIG. 5, the first source container curved track portion 9.1 and the second source container curved track portion 9.2 extend over the same source container angular range W1, the first target container curved track portion 11.1 and the second target container curved track portion 11.2 extend over the same target container angular range W2, wherein the source container angular range W1 differs from the target container angular range W2 such that a different number of source containers 2 and target containers 3 can be positioned within the operating region of the robot arm 4. In the case of the third embodiment according to FIG. 4 and the fourth embodiment according to FIG. 5, the target container angular range W2 is significantly larger than the source container angular range W1.

The various embodiments according to FIG. 4 to FIG. 6 accordingly show a conveyor system 7 comprising the two first conveyor tracks 6.1, which are designed and configured as feed tracks, each for conveying source containers 2 and target containers 3 to a picking region 5, and comprising the two second conveyor tracks 6.2, which are designed and configured as removal tracks, each for conveying source containers 2 and target containers 3 out of the picking region 5.

The picking region 5 of the conveyor system 7 is formed by the arcuate first curved track portions 6a of the first conveyor tracks 6.1 and the arcuate second curved track portion 6b of the second conveyor tracks 6.2.

The conveyor system 7 comprises corresponding drivable cross conveyors 20, which are designed and configured to actively transfer each source container 2 or target container 3 between the first curved track portions 6a of the first conveyor tracks 6.1 and the second curved track portions 6b of the second conveyor tracks 6.2 in each case.

The at least one first conveyor track 6.1 can, for example, be formed by a first roller track 6.1a, which comprises a plurality of rotationally drivable first rollers 21 that are evenly spaced apart from one another in the conveying direction, and the at least one second conveyor track 6.2 can be formed by a second roller track 6.2a, which comprises a plurality of rotationally drivable second rollers 22 that are evenly spaced apart from one another in the conveying direction.

The drivable cross conveyor 20 can be formed by at least one belt or chain lifting transfer unit arranged between two adjacent rollers of the first conveyor track 6.1 and/or the second conveyor track 6.2.

In the fourth embodiment according to FIG. 5, for example, a plurality of drivable cross conveyors 20 can be provided on the first curved track portion 6a and the second curved track portion 6b for the target containers 3.

Each first curved track portion 6a of the first roller track 6.1a and each second curved track portion 6b of the second roller track 6.2a can be extended in parallel with one another, as shown, such that each first curved track portion 6a and each second curved track portion 6b each lie on two different concentric circular paths having different radii.

In the case of the present embodiments in FIG. 2 to FIG. 6, the robot arm 4 is positioned in the center of the two circular paths on which the first curved track portions 6a of the first roller track 6.1a and the second curved track portion 6b of the second roller track 6.2a lie.

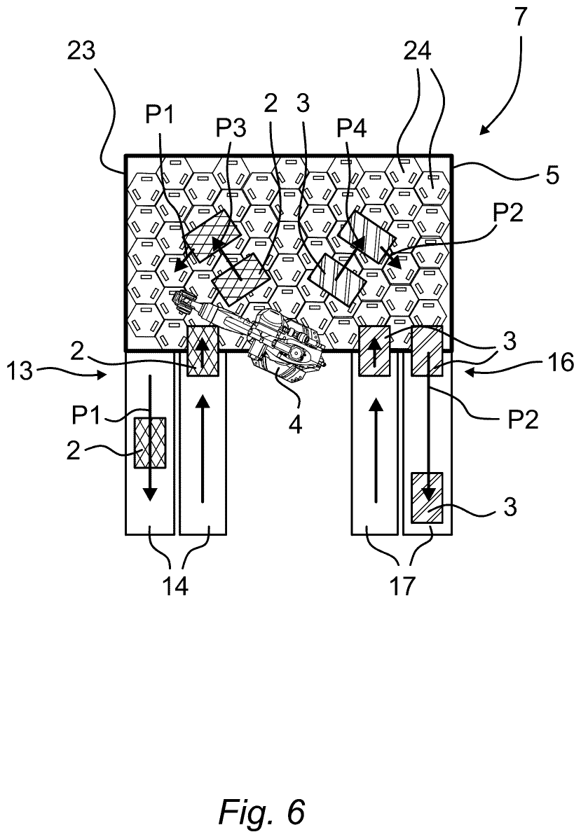

As shown in FIG. 6, the steps of the method can also be carried out by means of an omnidirectional conveyor table 23 which extends over the operating region of the robot arm 4 in the picking region 5. The first conveyor tracks 6.1 and the first curved track portions 6a can thus be formed by the omnidirectional conveyor table 23, which comprises a plurality of omnidirectional conveyor units 24 that can be driven individually or in groups and can be controlled in such a way that a conveyed source container 2 or target container 3 can be automatically moved on the omnidirectional conveyor table 23 on a first trajectory, which forms the first conveyor track 6.1 and/or the arcuate first curved track portion 6a.

In the same way, the second conveyor tracks 6.2 and the second curved track portions 6b can be formed by the omnidirectional conveyor table 23, the omnidirectional conveyor units 24 of which can be controlled such that a source container 2 or target container 3 to be conveyed away can be automatically moved on the omnidirectional conveyor table 23 along a second trajectory, which forms the second conveyor track 6.2 and/or the arcuate second curved track portion 6b.

The drivable cross conveyor 20 can also be formed by the omnidirectional conveyor table 23 in this respect, the omnidirectional conveyor units 24 of which can be controlled in such a way that a source container 2 or target container 3 to be automatically transferred can be automatically moved on the omnidirectional conveyor table 23 radially to the first trajectory and the second trajectory from a position on the first trajectory to a position on the second trajectory.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A method for automatically picking general cargo objects (1) from source containers (2) into target containers (3) by means of an automatically controlled robot arm (4) in a picking region (5), comprising the steps of:
conveying a source container (2) or a target container (3) to the picking region (5) on a first conveyor track (6.1) which is designed as a feed track, wherein the source container (2) or the target container (3) is moved in the picking region (5) along an arcuate first curved track portion (6a) of the first conveyor track (6.1) into an operating region of the robot arm (4),
automatically transferring the source container (2) or target container (3) conveyed on the feed track into the picking region (5) from the arcuate first curved track portion (6a) of the first conveyor track (6.1) to an arcuate second curved track portion (6b) of a second conveyor track (6.2) lying next to the first curved track portion (6a) of the first conveyor track (6.1), which second conveyor track forms a removal track, and
conveying the source container (2) or the target container (3) out of the picking region (5) on the second conveyor track (6.2), wherein the source container (2) or the target container (3) is moved in the picking region (5) along the arcuate second curved track portion (6b) of the second conveyor track (6.2) out of the operating region of the robot arm (4).

2. The method according to claim 1, characterized in that an automatically controlled drivable cross conveyor (20) is used to transfer the source container (2) or target container (3) conveyed into the picking region (5) on the feed track from the arcuate first curved track portion (6a) of the first conveyor track (6.1) into the arcuate second curved track portion (6b) of the second conveyor track (6.2) lying next to the first curved track portion (6a) of the first conveyor track (6.1).

3. The method according to claim 1, characterized in that an auxiliary robot arm that differs from the automatically controlled robot is used to transfer the source container (2) or target container (3) conveyed into the picking region (5) on the feed track from the arcuate first curved track portion (6a) of the first conveyor track (6.1) into the arcuate second curved track portion (6b) of the second conveyor track (6.2) lying next to the first curved track portion (6a) of the first conveyor track (6.1).

4. The method according to claim 1, characterized by the steps of:
conveying a source container (2) to the picking region (5) within the operating region of the robot arm (4) on a first source container curved track portion (9.1) of a first source container conveyor track (8.1) extending in an arc shape around the robot arm (4), in which the first source container curved track portion (9.1) forms a source container feed track,
conveying a target container (3) to the picking region (5) within the operating region of the robot arm (4) on a first target container curved track portion (11.1) of a first target container conveyor track (10.1) extending in an arc shape around the robot arm (4) in which the first target container curved track portion (11.1) forms a target container feed track,
automatically moving at least one general cargo object (1) from the source container (2) to the target container (3) by means of the robot arm (4) before or after automatically transferring the source container (2) and/or the target container (3),
automatically transferring the source container (2) conveyed on the source container feed track into the picking region (5) from the arcuate first source container curved track portion (9.1) of the first source container conveyor track (8.1) into an arcuate second source container curved track portion (9.2) of a second source container conveyor track (8.2) lying next to the first source container curved track portion (9.1) of the first source container conveyor track (8.1), which second source container conveyor track forms a source container removal track,
automatically transferring the target container (3) conveyed on the target container feed track into the picking region (5) from the arcuate first target container curved track portion (11.1) of the first target container conveyor track (10.1) into an arcuate second target container curved track portion (11.2) of a second target container conveyor track (10.2) lying next to the first target container curved track portion (11.1) of the first target container conveyor track (10.1), which second target container conveyor track forms a target container removal track,
conveying the source container (2) out of the picking region (5) on the second source container conveyor track (8.2), wherein the source container (2) is moved in the picking region (5) along the arcuate second source container curved track portion (9.2) of the second source container conveyor track (8.2) out of the operating region of the robot arm (4),
conveying the target container (3) out of the picking region (5) on the second target container conveyor track (10.2), wherein the target container (3) is moved in the picking region (5) along the arcuate second target container curved track portion (11.2) of the second target container conveyor track (10.2) out of the operating region of the robot arm (4).

5. The method according to claim 4, characterized in that the automatic transfer of the source container (2) is carried out at a distal end portion (12) of the first source container curved track portion (9.1) and the second source container curved track portion (9.2), which distal end portion (12) is remote from an opposite connection portion (13) of the first source container curved track portion (9.1) and the second source container curved track portion (9.2), at which connection portion connecting conveyor tracks (14) are connected to the first source container conveyor track (8.1) and the second source container conveyor track (8.2), and/or the automatic transfer of the target container (3) is carried out at a distal end portion (15) of the first target container curved track portion (11.1) and the second target container curved track portion (11.2), which distal end portion (15) is remote from an opposite connection portion (16) of the first target container curved track portion (11.1) and the second target container curved track portion (11.2), at which connection portion connecting conveyor tracks (17) are connected to the first target container conveyor track (10.1) and second target container conveyor track (10.2).

6. The method according to claim 4, characterized in that the automatic transfer of the source container (2) is carried out at a proximal connection portion (18) of the first source container curved track portion (9.1) and the second source container curved track portion (9.2), which proximal connection portion (18) is remote from an opposite end portion (12) of the first source container curved track portion (9.1) and the second source container curved track portion (9.2), connecting conveyor tracks (17) being connected to the first source container conveyor track (6.1) and the second source container conveyor track (6.2) at the proximal connection portion (18), and/or the automatic transfer of the target container (3) is carried out at a proximal connection portion (19) of the first target container curved track portion (11.1) and the second target container curved track portion (11.2), which proximal connection portion (19) is remote from an opposite end portion (15) of the first target container curved track portion (11.1) and the second target container curved track portion (11.2), connecting conveyor tracks (17) being connected to the first target container conveyor track (10.1) and the second target container conveyor track (10.2) at the proximal connection portion (19).

7. The method according to claim 4, characterized in that the first source container curved track portion (9.1) and the second source container curved track portion (9.2) extend over the same source container angular range (W1), the first target container curved track portion (11.1) and the second target container curved track portion (11.2) extend over the same target container angular range (W2), and the source container angular range (W1) differs from the target container angular range (W2) such that a different number of source containers (2) and target containers (3) can be positioned within the operating region of the robot arm (4).

8. The method according to claim 1, characterized in that the steps of the method according to any one of claims 1 to 3 are carried out by means of an omnidirectional conveyor table (23) which extends over the operating region of the robot arm (4) within the picking region (5).

9. The method according to claim 8, characterized by the steps of:
conveying the source container (2) or the target container (3) to the picking region (5) on the first conveyor track (6.1), the source container (2) or the target container (3) thereby being moved along the arcuate first curved track portion (6a) of the first conveyor track (6.1) into the operating region of the robot arm (4) in the picking region (5), by at least the first curved track portion (6a) being formed by the omnidirectional conveyor table (23), which comprises a plurality of omnidirectional conveyor units (24) that can be driven individually or in groups and are controlled such that a conveyed source container (2) or target container (3) on the omnidirectional conveyor table (23) is automatically moved along a first trajectory which forms the arcuate first curved track portion (6a),
automatically transferring the source container (2) or target container (3) conveyed on the feed track into the picking region (5) from a position on the first trajectory to a position on a second trajectory that extends alongside the first trajectory by controlling the omnidirectional conveyor units (24) in such a way that a source container (2) or target container (3) on the omnidirectional conveyor table (23) that is to be transferred is automatically moved radially from the first trajectory to the second trajectory, which forms the arcuate second curved track portion (6b), and
conveying the source container (2) or the target container (3) out of the picking region (5) on a second conveyor track (6.2) which extends along the second trajectory, the source container (2) or the target container (3) thereby being moved in the picking region (5) along the arcuate second curved track portion (6b) of the second conveyor track (6.2) out of the operating region of the robot arm (4) by at least the second curved track portion (6b) being formed by the omnidirectional conveyor table (23), the omnidirectional conveyor units (24) of which are controlled in such a way that a source container (2) or target container (3) on the omnidirectional conveyor table (23) that is to be conveyed away is automatically moved along the second trajectory.

10. A conveyor system for conveying transport containers on conveyor tracks (6.1, 6.2), in particular for carrying out a method according to claim 1, comprising:
at least one first conveyor track (6.1), which is designed and configured as a feed track, for conveying transport containers to a picking region (5) of the conveyor system (7)
at least one second conveyor track (6.2), which is designed and configured as a removal track, for conveying transport containers out of the picking region (5) of the conveyor system (7),
wherein the picking region (5) of the conveyor system (7) is formed by an arcuate first curved track portion (6a) of the first conveyor track (6.1) and an arcuate second curved track portion (6.2) of the second conveyor track (6.2) extending beside the first curved track portion (6a) of the first conveyor track (6.1), and comprising
a drivable cross conveyor (20) which is designed and configured to actively transfer each transport container between the first curved track portion (6a) of the first conveyor track (6.1) and the second curved track portion (6b) of the second conveyor track (6.2).

11. The conveyor system according to claim 10, characterized in that the at least one first conveyor track (6.1) is formed by a first roller track (6.1a) which comprises a plurality of rotationally drivable first rollers (21) that are evenly spaced apart from one another in the conveying direction, the at least one second conveyor track (6.2) is formed by a second roller track (6.2a) which comprises a plurality of rotationally drivable second rollers (22) that are evenly spaced apart from one another in the conveying direction, and/or the drivable cross conveyor (20) is formed by at least one belt or chain lifting transfer unit arranged between two adjacent rollers (21, 22) of the first conveyor track (6.1) and/or the second conveyor track (6.2).

12. The conveyor system according to claim 11, characterized in that the first curved track portion (6a) of the first roller track (6.1a) and the second curved track portion (6b) of the second roller track (6.2a) are arranged so as to extend in parallel next to one another such that the first curved track portion (6a) and the second curved track portion (6b) lie on two different concentric circular paths having different radii.

13. The conveyor system according to claim 12, characterized in that the robot arm (4) is positioned in the center of the two circular paths on which the first curved track portion (6a) of the first roller track (6.1a) and the second curved track portion (6b) of the second roller track (6.2a) lie.

14. The conveyor system according to claim 10, characterized in that the at least one first conveyor track (6.1) and/or the first curved track portion (6a) is/are formed by an omnidirectional conveyor table (23) which comprises a plurality of omnidirectional conveyor units (24), which can be driven individually or in groups and can be controlled in such a way that a conveyed source container (2) or target container (3) on the omnidirectional conveyor table (23) can be automatically moved on a first trajectory which forms the first conveyor track (6.1) and/or the arcuate first curved track portion (6a), and the at least one second conveyor track (6.2) and/or the second curved track portion (6b) is/are formed by the omnidirectional conveyor table (23), the omnidirectional conveyor units (24) of which can be controlled in such a way that a source container (2) or target container (3) on the omnidirectional conveyor table (23) that is to be conveyed away can be automatically moved along a second trajectory which forms the second conveyor track (6.2) and/or the arcuate second curved track portion (6b), and/or the drivable cross conveyor (20) is formed by the omnidirectional conveyor table (23), the omnidirectional conveyor units (24) of which can be controlled in such a way that a source container (2) or target container (3) on the omnidirectional conveyor table (23) that is to be automatically transferred can be automatically moved radially with respect to the first trajectory and second trajectory from a position on the first trajectory to a position on the second trajectory.

15. A computer program product comprising a machine-readable carrier, on which a program code is stored, which can be read by a picking control device of a conveyor system (7), and instructs and/or configures the picking control device to implement a method according to claim 1 when the program code is executed by the picking control device.
